(19) United States
(12) Patent Application Publication
(10) Pub. No.: US 2018/0038020 A1
(43) Pub. Date: Feb. 8, 2018

(54) FIRE RETARDANT FABRIC FOR LATEX FOAM BEDS

(71) Applicant: FINE COTTON FACTORY INC., Toronto (CA)

(72) Inventor: Biren PATEL, Toronto (CA)

(21) Appl. No.: 15/671,385

(22) Filed: Aug. 8, 2017

Related U.S. Application Data
(60) Provisional application No. 62/372,060, filed on Aug. 8, 2016.

(51) Int. Cl. D02G 3/44; D01F 6/40; A47C 31/00; B32B 5/02; B32B 5/08; B32B 5/26; D02G 3/04; D04B 1/16

(52) U.S. Cl. CPC D02G 3/443; D02G 3/045; D01F 6/40; D04B 1/16; B32B 5/026; B32B 5/08; B32B 5/26; A47C 31/001; D10B 2101/10; D10B 2201/20; D10B 2321/101; D10B 2331/02; D10B 2331/04; D10B 2505/08; B32B 2262/14

(57) ABSTRACT

A one-fabric fire resistant (FR) solution having 2 or more layers of FR yarns knit together into one fabric, the at 2 or more layers including a face layer and a back layer, the back layer includes a silica yarn.

### CROSS-REFERENCE TO RELATED APPLICATIONS

This application claims the benefit of provisional patent application Ser. No. 62/372,060, filed Aug. 8, 2016, the full content of which is incorporated herein by reference.

### FIELD OF THE INVENTION

The present invention relates in general to fire retardant fabrics for latex foam beds.

### BACKGROUND OF THE INVENTION

The United States Consumer Product Safety Commission (CPSC) issued Standard for the Flammability (Open Flame) of Mattress Sets that establishes performance requirements (the “16 CFR 1633 requirements”) based on research conducted by the National Institute of Standards and Technology. Mattresses and mattress foundation sets that comply with the requirements will generate a smaller size fire with a slower growth rate, thus reducing the possibility of flashover occurring. During the test, the mattress or mattress set is located on top of a steel rig and exposed to two T-shaped burners with a total burner heat output of 27 kW. The side burner is applied for 50 seconds and the top burner is applied for 70 seconds. The fire is then allowed to develop freely. The smoke gases produced during the test are collected by a hood and exhaust system from where samples are taken for gas analysis. To meet the 16 CFR 1633 requirements, a mattress must maintain a heat release rate of less than 200 kW during the first 30 minutes of the test and, also, that the total heat release be less than 15 MJ in the first 10 minutes of the test.

Foam and latex mattresses are a challenge to meet the 16 CFR 1633 requirements.

Since the adoption of the 16 CFR 1633 open flame burn tests by the CPSC and the continuing use of the 16 CFR 1632 cigarette burn tests requiring 2 mattress surfaces (bare mattress surface side and a side covered with two sheets) have been in effect there has been a need for a single fabric barrier to pass both tests when manufacturing a latex or latex containing bed. Currently the only solution for latex-based mattresses to meet 16 CFR 1632/1633 is having at least 2 different (i.e. separate) barrier systems (so called two layer solution). Examples are 2 barrier socks or a quilted non-woven flame resistant layer along with a flame resistant sock. The two layer solution adversely effects the softness and recovery properties as well as extra costs by having and installing 2 barrier systems. Thus, what is needed is a comfortable flame resistant fabric with improved performance during the 16 CFR 1632/1633 tests and that it may be used without modification on a wide range of mattress sizes.

Presently, no one layer solution has passed the 16 CFR 1632 and 16 CFR 1633 requirements when used on a mattress containing 3 inches (7.62 cm) or more than 3 inches thick piece of latex through a 100% latex 12 inch (30.48 cm) mattress.

In view of the foregoing, a new and innovative fire resistant knit that overcomes the deficiencies of the prior art is needed.

### SUMMARY OF THE INVENTION

The present invention provides for a one-fabric solution with 2 or more layers. The two or more layers fabric combines at least 2 layers of fire resistant (FR) yarns knit together into one fabric. The at least 2 layers include a face layer and a back layer.

In one embodiment of the present invention, the face layer is made of yarn with 2 or more staple FR fibers. In one aspect, the two or more staple FR fibers of the face layer include 32 LOI (limit oxygen index) modacrylic, and FR cellulose fiber. In another aspect the face layer includes 32 LOI (limit oxygen index) modacrylic, FR cellulose fiber and non-FR polyester fiber.

In another embodiment of the present invention, the back layer is made of a core-spun yarn having continuous filament silica fiber, polyamide continuous filament fiber, and spun fibers of 32 LOI (limit oxygen index) modacrylic, FR cellulose fiber and non-FR polyester fiber. In another embodiment of the present invention, the back layer is made of a core-spun yarn having about 41% of continuous filament silica fiber, and about 7% of polyamide continuous filament fiber.

In another embodiment of the present invention, the face layer and the back layer of the fabric is 1632 and 1633 compliant.

In another embodiment of the present invention, the one-fabric solution consists of 3 layers knit together into one fabric, the face and back layers of any of the previous embodiments, and a middle layer.

In another embodiment of the present invention, the middle layer is a high denier textured polyester. In one aspect of this embodiment, the middle layer further includes an FR spun yarn.

In another embodiment of the present invention, the middle layer includes a high denier textured polyester and a FR spun yarn made of about 50% 32 LOI modacrylic, about 25% FR cellulose fiber and about 25% of non-FR polyester fiber.

In another aspect the present invention provides for a foam mattress cover, the foam mattress cover made of the one-fabric solution according to any of the previous embodiments.

### BRIEF DESCRIPTION OF THE DRAWINGS

The following figures illustrate various aspects and preferred and alternative embodiments of the invention.

FIG. 1 is a knitting diagram that represents how the knitting actually takes place on knitting machine. Symbols: Box=welt and X=knit. For the X and Y, X is a width and Y is length.

FIG. 2 is a knitting diagram that represents how the knitting actually takes place on knitting machine as in FIG. 1, except 1-109+# of feeds and 1-16=width of the pattern. Symbols: Box=welt and X=knit. For the X and Y, X is a width and Y is length.

### DESCRIPTION OF THE INVENTION

Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. In order to aid in the understanding and preparation of the within invention, the following illustrative, non-limiting, examples are provided.

The term “knit” may be used as a verb (to make (a fabric or garment) by intertwining yarn or thread in a series of connected loops either by hand, with knitting needles, or on a machine) or as a noun (a fabric or garment made by knitting).

The terms “fiber” and “fibers”, as used in the specification and appended claims, refer to any slender, elongated structure that can be carded or otherwise formed into a thread. Fibers are characterized as being no longer than 25 mm. Examples include “staple fibers”, a term that is well-known in the textile art.

The term “yarn”, as used in the specification and appended claims, refers to a structure comprising a plurality of threads.

The term “fire retardant” refers to a fabric, felt, yarn or thread that is slow to burn. The term “fire resistant” refers to a fabric, felt, yarn or strand that is difficult to burn.

As used in the specification and appended claims, the term “fire” is meant to include flame and/or heat.

A one-layer solution fire resistant (FR) fabric with 2 or more layers that may contain at least 2 or more fibers per yarn that are FR and will prevent mattresses produced Talalay, natural, and/or synthetic latex foam from failing the 16 CFR 1632 and 16 CFR 1633 mattress burn tests. The combination of FR fibers of the fire resistant fabric of the present invention has a unique fire resistant mechanisms that work conjunctionally to prevent latex foam from burning.

The present invention relates also to the manufacture of fire resistant fabrics and the use of these fabrics in the manufacturing of fire resistant articles to include but not limited to items of furniture and mattresses.

The fabric of the present invention may include FR fibers in all layers of the fabric (2, 3, 4, 5 or more layers). The two or more layers are knit together to make the one-fabric solution of the present invention.

The back layer of the fabric of the present invention, also referred to as the second side, which forms the side of the fabric that touches (or is in contact with) the article to be covered and protected from flames, may be made of a core-spun yarn having a continuous filament silica yarn, 32 Limiting Oxygen Index (LOI) modacrylic, and flame resistant cellulose fiber (viscose rayon, tencel, modal, bamboo, cotton, and any other flame resistant cellulose fiber). The back layer may also a thermoplastic fiber. The back layer may also include non-FR polyester staple fibers. The back layer may include, for example about 41% of the continuous filament silica fiber and about 7% of the polyamide continuous filament fiber, about 26% 32LOI modacrylic about 13% of the FR cellulose fiber, and about 13% of the non-FR polyester. In one embodiment, the back layer includes a glass fiber (core rap or naked). In one embodiment, the glass fiber covers at least 60% of the back layer of the fabric.

The ranges of fibers each layer of the one-fabric solution of the present invention may be about 40-60% of the continuous filament silica fiber, about 4-10% of the polyamide continuous filament fiber, about 20-35% of the 32LOI modacrylic, 20-30% of the FR cellulose and about 20-30% of the non-FR polyester.

A one-fabric solution with 2 knitted layers may have a yarn made up of from about 35% to about 65% of the 32 Limiting Oxygen Index modacrylic, from about 15% to about 50% fire resistant cellulose fiber. If the fire resistant fabric with 2 layers also include the thermoplastic fiber, then from about 10% to about 25% of the thermoplastic fiber.

The face layers of 2-layers or 3-layers fabric solution may be made of a yarn that contains 50% 32 LOI modacrylic, about 25% FR cellulose fiber and about 25% of non-FR polyester fiber.

The one-fabric solution may consist of 3 layers knit together into one fabric, the face and back layers of any of the previous embodiments, and a middle layer in between the face and back layers. The middle layer may be a high denier textured polyester, and it may further include an FR spun yarn. For example, the middle layer includes a high denier textured polyester and a FR spun yarn made of 32 LOI modacrylic, FR cellulose fiber and non-FR polyester fiber.

The three layers may contain the following: (1) face layer: spun yarn from staple fibers of 32 LOI modacrylic (30-60%, preferably 50%), FR cellulose fiber (15-40%, preferably 25%), and non-FR polyester (15-40%, preferably 25%); (2) middle layer of filament and spun yarns of denier textured polyester (150-900 denier range, preferably 300 denier), spun yarn of 32 LOI modacrylic (35-60%, preferably 50%), fR cellulose (15-40%), non-FR polyester (15-40%); and (3) back layer: core-spun continuous filament silica fiber (35-65%, preferably 41%), covered with continuous filament polyamide fiber (5-15%, preferably 7%) and wrapped with 32 LOI modacrylic (20-30%, preferably 26%), FR cellulose (10-20%, preferably 13%) and non-FR polyester (10-20%, preferably 13%).

The FR one-fabric solution of the present invention may range in weight from 225 grams per meter square to about 850 grams per square meter, including 270 g/m², 400 g/m² and 620 grams/m². A one-fabric solution with two layers may weigh between about 225-620 g/m². A one-fabric solution with three layers may weigh between about 270 g/m²-850 g/m².

Latex beds of Talalay, natural, or synthetic latex will pass flame resistant test 16 CFR 1632 and 16 CFR 1633 for mattresses when a sock type cover of the present invention is placed on the bed next to the latex with another finished mattress cover on the outside of the bed.

One particular application of the fire resistant double knit fabric of the present invention is the manufacturing of fire resistant covers—which may be referred to as “socks”—for mattresses that meet the requirements of 16 CFR 1632/1633 when used to protect foam or latex mattresses.

As such, in one embodiment, the present invention provides for a fire resistant for covering a mattress. The sock may include a fire resistant section to cover the mattress' top, lateral sides, and a peripheral portion of the bottom side of the mattress.

It should be understood that such a modified sock may be designed to cover other objects that may require a fire barrier.

The two layer fabric may be used to make the FR socks previously described. The mattress manufacturer may install the FR sock and then install a decorative non-FR fabric cover to complete the mattress being produced. The one-fabric solution of two layers allows the mattress manufacturer to accomplish a bed that passes TB 1632 and TB 1633 tests by covering the foam of the mattress with a sock made from the one-fabric solution of the present invention and accomplish his original mattress design by using the same cover originally specified.

Three layer fabric will also pass TB 1632 and TB 1633 tests while producing a face side pattern desired by the customers to be used as a single cover solution.

Often mattress manufacturers may want to continue using existing non-FR covers. This necessitates the mattress manufacturer to use a number of FR mattress covers to pass the mentioned tests. By using the one-fabric, 2 layer solution of the present invention, the mattress manufacturer will end up with a bed with better feel properties, while passing the two mentioned tests.

Through the embodiments that are illustrated and described, the currently contemplated best mode of making and using the invention is described. Without further elaboration, it is believed that one of ordinary skill in the art can, based on the description presented herein, utilize the present invention to the full extent.

The fire resistant fabrics of the present invention be produced on circular single jersey machines, circular double jersey machines, double needle bar warp knitting machines, and double or more than double warp weaving looms.

### EXAMPLES

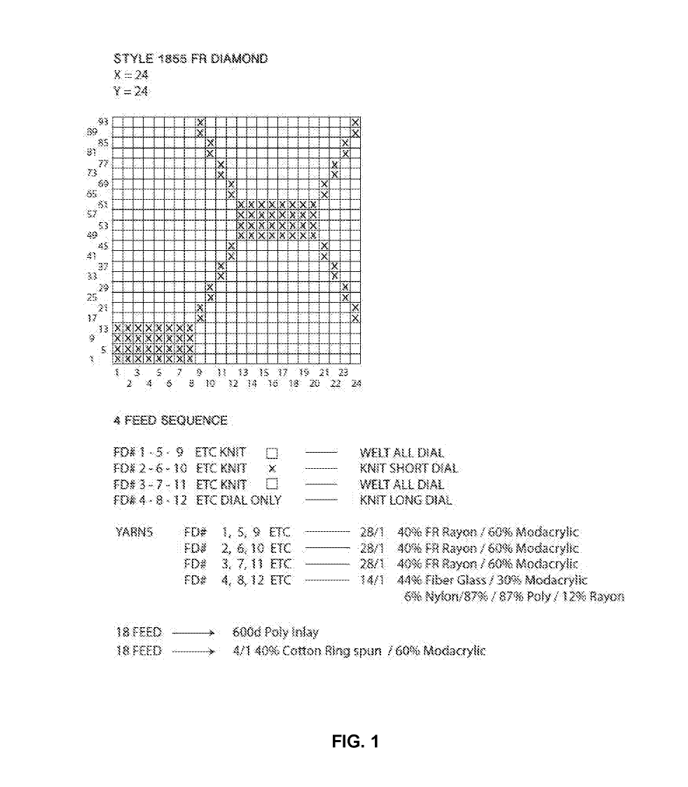

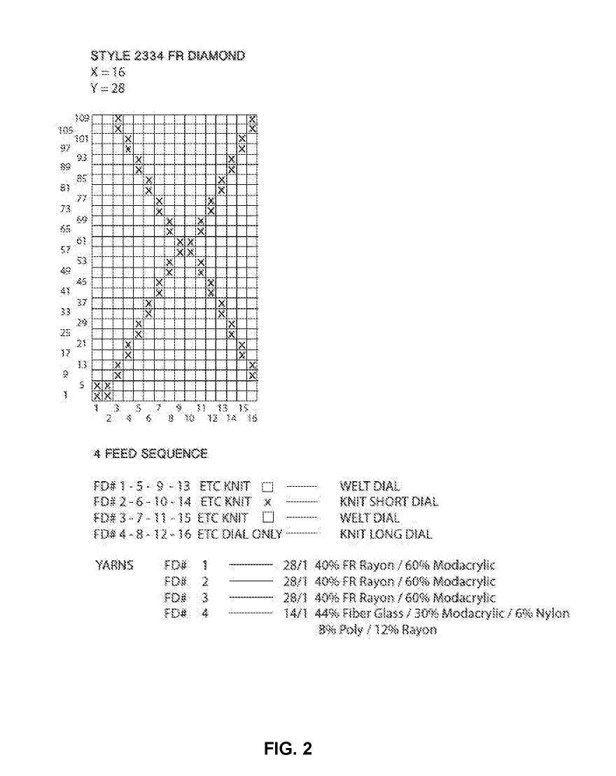

FIGS. 1 and 2 illustrate two styles of one-fabric solutions of the present invention.

FIG. 1 shows it's a 4 feed sequence. #1 to 93 is a knitting sequences and 1 to 24 represents width of the pattern.

FIG. 2 is the same as in FIG. 1, except 1-109+# of feeds and 1-16=width of the pattern.

Although the description above contains many specificities, these should not be construed as limiting the scope of the invention, but as merely providing illustrations of some of the presently embodiments of this invention. Thus the scope of the invention should be determined by the appended claims and their legal equivalents, rather than by the examples given.

1. A one-fabric fire resistant (FR) solution having 2 or more layers of FR yarns knit together into one fabric, the at 2 or more layers including a face layer and a back layer, wherein the back layer includes a silica yarn.

2. The one-fabric FR solution of claim 1, wherein the silica yarn covers at least 60% of the back layer.

3. The one-fabric FR solution of claim 1, wherein the face layer is made of yarn with 2 or more staple FR fibers.

4. The one-fabric FR solution of claim 3, wherein the two or more staple FR fibers of the face layer include 32 LOI (limit oxygen index) modacrylic, and FR cellulose fiber.

5. The one-fabric FR solution of claim 4, wherein the face layer further includes a non-FR polyester fiber.

6. The one-fabric FR solution of claim 3, wherein the back layer is made of a core-spun yarn having continuous filament silica fiber, polyamide continuous filament fiber, and spun fibers of 32 LOI (limit oxygen index) modacrylic, FR cellulose fiber and non-FR polyester fiber.

7. The one-fabric FR solution of claim 1, wherein the one-fabric solution consists of 3 layers knit together into one fabric, the face layer, the back layer and a middle layer.

8. The one-fabric FR solution of claim 7, wherein the middle layer is a high denier textured polyester.

9. The one-fabric FR solution of claim 7, wherein the middle layer includes a high denier textured polyester and a FR spun yarn made of 32 LOI modacrylic, FR cellulose fiber and non-FR polyester fiber.

10. A foam mattress cover, the foam mattress cover made of the one-fabric solution of claim 9.
